(19) United States
(12) Patent Application Publication
(10) Pub. No.: US 2021/0081612 A1
(43) Pub. Date: Mar. 18, 2021

(54) RELATIONSHIP ESTIMATION MODEL LEARNING DEVICE, METHOD, AND PROGRAM

(71) Applicant: NIPPON TELEGRAPH AND TELEPHONE CORPORATION, Tokyo (JP)

(72) Inventors: Itsumi SAITO, Tokyo (JP); Kyosuke NISHIDA, Tokyo (JP); Junji TOMITA, Tokyo (JP); Hisako ASANO, Tokyo (JP)

(73) Assignee: NIPPON TELEGRAPH AND TELEPHONE CORPORATION, Tokyo (JP)

(21) Appl. No.: 16/970,315

(22) PCT Filed: Feb. 15, 2019
(86) PCT No.: PCT/JP2019/005620

§ 371 Date: Aug. 14, 2020

(30) Foreign Application Priority Data
Feb. 16, 2018 (JP) 2018-026507

(51) Int. Cl. G06F 40/289; G06N 3/02; G06K 9/62; G06F 40/169; G06F 40/44

(52) U.S. Cl. CPC G06F 40/289; G06N 3/02; G06F 40/44; G06F 40/169; G06K 9/6256

(57) ABSTRACT

A relationship between phrases can be accurately estimated without incurring the cost of generating learning data. A learning data generation unit 62 extracts a pair of phrases having a dependency relationship with a segment containing a predetermined connection expression representing a relationship between phrases based on a dependency analysis result for input text, and generates a triple consisting of the extracted pair of phrases, and the connection expression or a relation label indicating a relationship represented by the connection expression. A learning unit 63 learns the relationship estimation model for estimating a relationship between phrases based on the triple generated by the learning data generation unit.

### TECHNICAL FIELD

The present invention relates to a relationship estimation model learning device, a method for the same, and a program for the same.

### BACKGROUND ART

Non-Patent Literature 1 uses a corpus as an input and acquires inter-event relation knowledge using co-occurrence information on a predicate-argument structure and a distribution of inter-node relations.

Non-Patent Literature 2 estimates a relation score by learning a neural network using a large amount of manually generated labeled data. The relation score is a numerical value indicating whether a triple {phrase 1, phrase 2, label} given as an input is correct or not.

### CITATION LIST

### Non-Patent Literature

Non-Patent Literature 1: Kenichi Otomo, Tomohide Shibata, Yoshio Kurohashi, “Acquisition of inter-event relation knowledge using co-occurrence information on predicate-argument structure and a distribution of inter-node relations”, Proceedings of the 17th Annual Meeting of the Language Processing Society (March 2011)

Non-Patent Literature 2: Xiang Li, Aynaz Taheri, Lifu Tu, Kevin Gimpel, “Commonsense Knowledge Base Completion”, Proc. of ACL, 2016.

### SUMMARY OF THE INVENTION

### Technical Problem

The method disclosed in Non-Patent Literature 1 has a problem in that when a relationship is estimated using a triple acquired by the method, only the triple appearing in the input corpus can be estimated.

The method disclosed in Non-Patent Literature 2 has a problem in that a relation score can be output for any triple, but it requires a high cost to generate a large amount of labeled data.

In order to solve the above problems, the present invention has been made, and an object of the present invention is to provide a relationship estimation model learning device that can learn a relationship estimation model that can accurately estimate a relationship between phrases without incurring the cost of generating learning data, a method for the same, and a program for the same.

### Means for Solving the Problem

In order to achieve the above objects, a relationship estimation model learning device according to the present invention is configured to include a learning data generation unit that extracts a pair of phrases having a predetermined relationship with a segment containing a predetermined connection expression representing a relationship between phrases based on a text analysis result for input text and generates a triple consisting of the extracted pair of phrases, and at least one of the connection expression and a relation label indicating a relationship represented by the connection expression; and a learning unit that learns a relationship estimation model for estimating the relationship between phrases based on the triple generated by the learning data generation unit.

A relationship estimation model learning method according to the present invention is such that a learning data generation unit extracts a pair of phrases having a predetermined relationship with a segment containing a predetermined connection expression representing a relationship between phrases based on a text analysis result for input text, and generates a triple consisting of the extracted pair of phrases, and at least one of the connection expression and a relation label indicating a relationship represented by the connection expression; and a learning unit learns a relationship estimation model for estimating a relationship between phrases based on the triple generated by the learning data generation unit.

A program according to the present invention is a program for causing a computer to function as each unit constituting the relationship estimation model learning device according to the present invention.

### Effects of the Invention

The relationship estimation model learning device, the method for the same, and the program for the same have an effect that a pair of phrases having a predetermined relationship with a segment containing a connection expression representing a relationship between phrases is extracted based on a text analysis result for input text, and a triple consisting of the pair of phrases, and at least one of the connection expression and a relation label is generated, thereby to be able to learn a relationship estimation model that can accurately estimate a relationship between phrases without incurring the cost of generating learning data.

### BRIEF DESCRIPTION OF DRAWINGS

FIG. 1 is a block diagram illustrating a configuration of a relationship estimation device according to an embodiment of the present invention.

FIG. 2 is a diagram for explaining a relation score calculation method.

FIG. 3 is a diagram for explaining a relation score calculation method.

FIG. 4 is a block diagram illustrating a configuration of a relationship estimation model learning device according to the embodiment of the present invention.

FIG. 5 is a block diagram illustrating a configuration of a learning data generation unit of the relationship estimation model learning device according to the embodiment of the present invention.

FIG. 6 is a diagram illustrating an example of input text.

FIG. 7 is a diagram illustrating an example of a dependency analysis result.

FIG. 8 is a diagram illustrating an example of a connection expression database.

FIG. 9 is a flowchart illustrating a relationship estimation model learning processing routine of the relationship estimation model learning device according to the embodiment of the present invention.

FIG. 10 is a flowchart illustrating a relationship estimation processing routine of the relationship estimation device according to the embodiment of the present invention.

### DESCRIPTION OF EMBODIMENTS

Hereinafter, with reference to the accompanying drawings, an embodiment of the present invention will be described in detail.

<Outline of the Embodiment of the Present Invention>

In relationship estimation, when a triple {phrase 1, phrase 2, relation label} consisting of two texts and a relation label indicating the relation between the two texts is given as input, a confidence score (hereinafter referred to a relation score) of the triple is output.

For example, the input triple is {text 1: amega furu (it rains), text 2: jimen ga nureru (ground gets wet), relation label: result} and the output is the relation score.

In the present embodiment, as the relation between two texts, a method for estimating whether the relation label is correct or not will be described.

Further, the embodiment of the present invention uses a dependency structure with a connection expression as a starting point to extract a triple consisting of phrases and the connection expression connecting the phrases. Then, the embodiment of the present invention uses the extracted triple to learn a relationship estimation model which is a neural network model for estimating the relation.

<Configuration of the Relationship Estimation Device According to the Embodiment of the Present Invention>

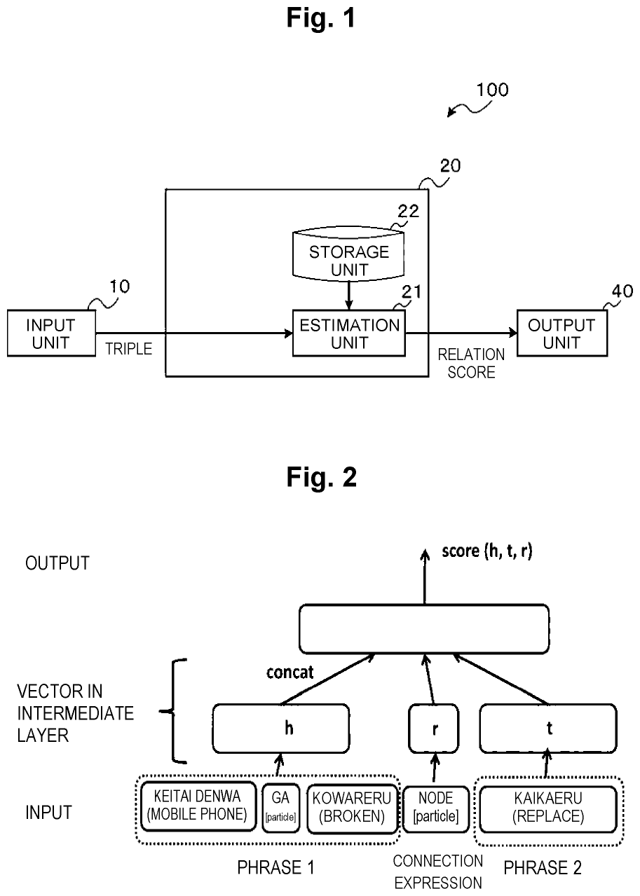

The configuration of the relationship estimation device according to the embodiment of the present invention will now be described. As illustrated in FIG. 1, a relationship estimation device 100 according to the embodiment of the present invention can be configured by a computer including a CPU, a RAM, and a ROM storing programs and various data for executing a relationship estimation processing routine to be described later. The relationship estimation device 100 functionally includes an input unit 10, a calculation unit 20, and an output unit 40 as illustrated in FIG. 1.

The input unit 10 receives a triple {phrase 1, phrase 2, connection expression} consisting of two phrases (texts) and a connection expression representing a relationship between the phrases.

The calculation unit 20 includes an estimation unit 21 and a storage unit 22.

The storage unit 22 stores a relationship estimation model learned by a relationship estimation model learning device 150 to be described later.

A neural network is used for the relationship estimation model and the learning method will be described later with the relationship estimation model learning device 150. The neural network may be any neural network. Alternatively, a different machine learning may be used, but the neural network is more effective.

The estimation unit 21 uses the relationship estimation model stored in the storage unit 22 to estimate the relation score with respect to the inputted triple and output the relation score from the output unit 40.

The relation score is a numerical value indicating whether or not the two phrases in the triple given as input have the relation indicated by the connection expression. For example, the relation score takes a value of 0 to 1, and the closer to 1, there exists a relation.

The processing of the estimation unit 21 will be described below.

First, the three inputs {phrase 1, phrase 2, connection expression} are converted to the respective vectors.

Let h be a vector of the converted phrase 1, t be a vector of the converted phrase 2, and r be a vector of the converted connection expression. The conversion method may be any method as long as the method vectorizes a phrase or word. The present embodiment uses the method of Non-Patent Literature 3.

[Non-Patent Literature 3] Tomas Mikolov, Ilya Sutskever, Kai Chen, Greg Corrado, and Jeffrey Dean. Distributed Representations of Words and Phrases and their Compositionality, In Proceedings of NIPS, 2013.

The following two methods can be considered for calculating the relation score.

(Score Calculation Method 1)

As illustrated in FIG. 2, h, t, and r are concatenated, and a relation score score(h, t, r), which is a one-dimensional output value, is output using a multilayer perceptron or the like.

(Score Calculation Method 2)

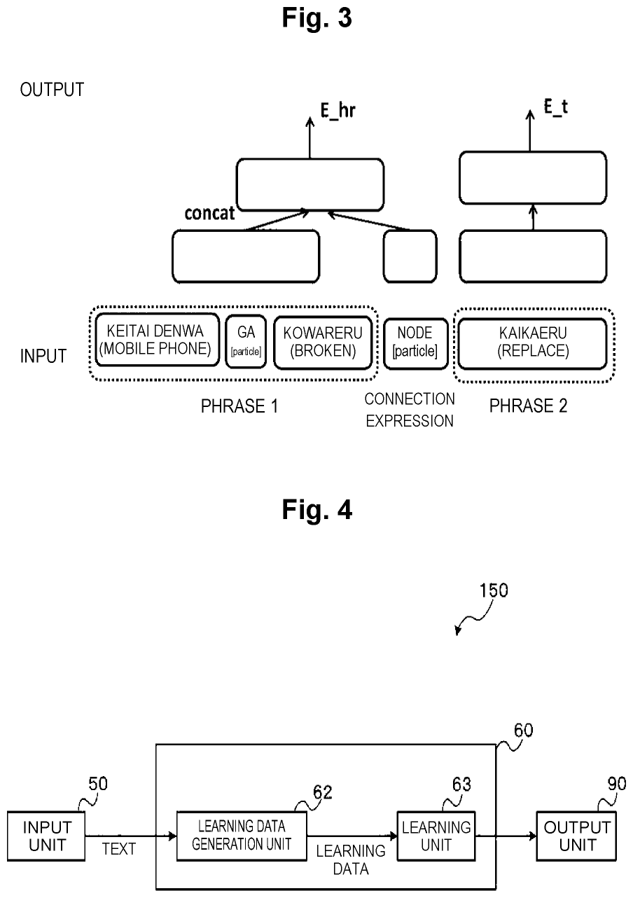

As illustrated in FIG. 3, h and r are concatenated, and an r-dimensional vector E_hr is output using a multilayer perceptron or the like, and an r-dimensional vector E_t is output from t using a multilayer perceptron or the like. Then, the relation score is calculated based on the closeness of E_hr and E_t. The closeness of the two vectors may be calculated, for example, using cosine similarity or the like.

For example, the estimation unit 21 outputs a relation score of 0.87 for the triple {phrase 1: amega furu (it rains), phrase 2: jimen ga nureru (ground gets wet), connection expression: node (conjunctive particle)}.

In addition, the estimation unit 21 determines the output relation score by a predetermined threshold and estimates whether or not there is a relationship that the phrase 1 and the phrase 2 have a relationship of “result” indicated by “node”. For example, when the value of the relation score is 0.6 and the threshold value is 0.4, it is estimated that there is a relationship because 0.6 is greater than 0.4. However, since the threshold determination may be required for knowledge acquisition or for reducing the score to 0/1, the value of the relation score may be output as is without performing the threshold determination depending on the application.

<Configuration of the Relationship Estimation Model Learning Device According to the Embodiment of the Present Invention>

Then, the configuration of the relationship estimation model learning device according to the embodiment of the present invention will be described. As illustrated in FIG. 4, the relationship estimation model learning device 150 according to the embodiment of the present invention can be configured by a computer including a CPU, a RAM, and a ROM storing programs and various data for executing a relationship estimation model learning processing routine to be described later. The relationship estimation model learning device 150 functionally includes an input unit 50, a calculation unit 60, and an output unit 90 as illustrated in FIG. 4.

The input unit 50 receives an input text.

The calculation unit 60 includes a learning data generation unit 62 and a learning unit 63.

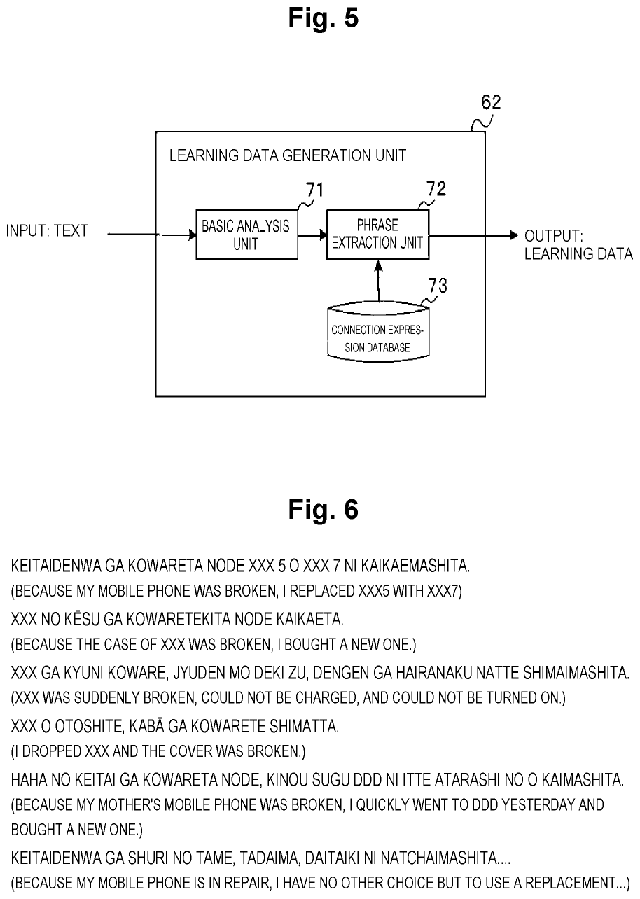

As illustrated in FIG. 5, the learning data generation unit 62 includes a basic analysis unit 71, a phrase extraction unit 72, and a connection expression database 73.

The basic analysis unit 71 performs dependency analysis on an input text.

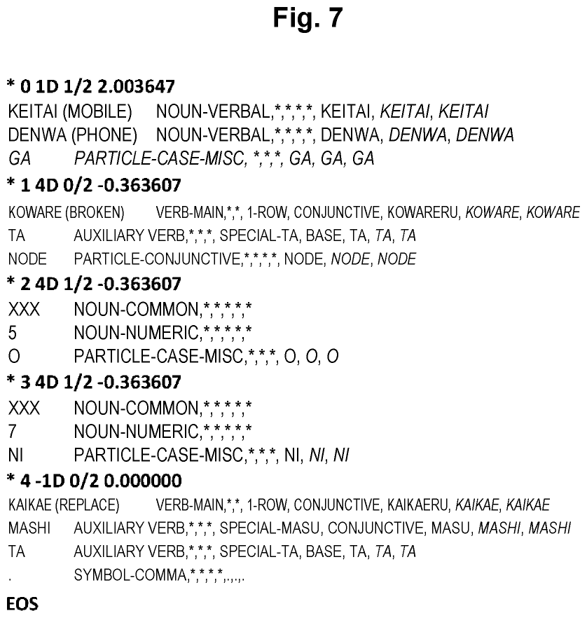

FIG. 6 illustrates an example of input text. FIG. 7 illustrates an example of a dependency analysis result. Dependency analysis may be of any type, and for example, CaboCha, a known morphological analyzer, is used.

The phrase extraction unit 72 extracts a phrase from the dependency analysis result. The present embodiment assumes that the phrase includes a subject and a predicate in a dependency relation as the minimum unit, and other up to n-number of adjective clauses (n is an arbitrary natural number).

As illustrated by an example of the dependency analysis result in FIG. 7, the following phrases are extracted. When a phrase is extracted, the original form of the analysis result (however, the original form is not necessarily required) obtained by converting “kowareta node (broken and thus)” to “kowareru (break)”, and “kaikaemashita (replaced)” to “kaikaeru (replace)” is used for extraction.

keitaidenwa ga kowareru (mobile phone is broken)

kaikaeru (replace)

xxx 7 ni kaikaeru (is replaced with xxx 7)

xxx 5 o kaeru (replace xxx5)

It should be noted that a phrase is basically extracted by assuming that a combination of a subject and a verb is used as a basic unit, but a sahen-noun verb alone may be used as a phrase.

In addition, each character string before and after the connection expression may be extracted as a phrase without considering the dependency relationship. For example, when there is a sentence “aaaa [connection expression] bbbb”, each of “aaaa” and “bbbb” may be extracted as a phrase. In this case, [connection expression] represents a segment containing the connection expression; and “aaaa” and “bbbb” represent the phrases having a positional relationship of being before and after across the segment containing the connection expression.

Then, the phrase extraction unit 72 extracts a phrase containing the connection expression and a phrase having a dependency relation with the segment from the pair of phrases and generates a triple consisting of {phrase 1, phrase 2, connection expression}.

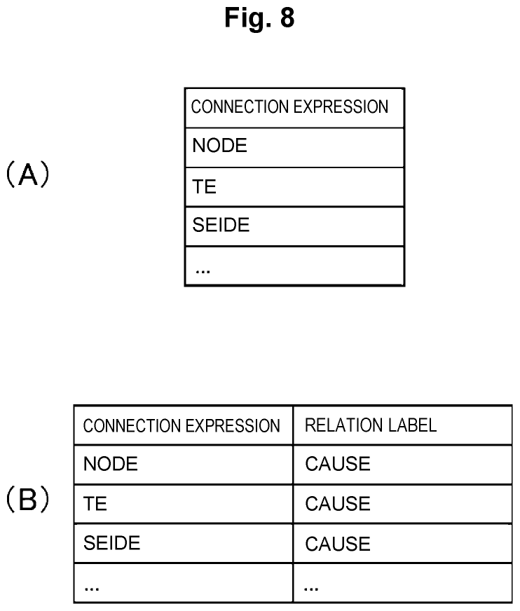

The present embodiment assumes that the connection expression is predetermined by an expression representing a relationship between phrases. Examples of the connection expression may include conjunctions such as “nanode”, “node”, “tame ni”, “to”, “tara”, “baai”, “toki”, “toki”, “ba”, “kara”, and “ga”. As illustrated in FIG. 8(A), the present embodiment assumes that the connection expressions are preliminarily stored in the connection expression database 73.

In the example of the dependency analysis results in FIG. 7, the following triples are generated.

{keitaidenwa ga kowareru (mobile phone is broken), kaikaeru (replace), node [conjunctive particle]}

{keitaidenwa ga kowareru (mobile phone is broken), xxx 7 ni kaikaeru (is replaced with xxx7), node [conjunctive particle]}

{keitaidenwa ga kowareru (mobile phone is broken), xxx 5 o kaikaeru (replace xxx5), node [conjunctive particle]}

Assuming that there are N types of connection expressions, there are N types of labels contained in the final triple.

In addition to the above described method (extraction method 1) of extracting a triple and outputting the triple as is, another embodiment of the phrase extraction unit 72 includes a method of performing the following three types of processing after extraction.

(Extraction Method 2)

As illustrated in FIG. 8(B), the present embodiment assumes that each relation label representing a connection expression and the connection expression is preliminarily stored in the connection expression database 73.

The connection expression database 73 is used to convert the connection expression to the relation label to output a triple {phrase 1, phrase 2, relation label}.

In the above example of the dependency analysis results in FIG. 7, the following triples are generated.

{keitaidenwa ga kowareru (mobile phone is broken), kaikaeru (replace), cause}

{keitaidenwa ga kowareru (mobile phone is broken), xxx 7 ni kaikaeru (is replaced with xxx7), cause}

{keitaidenwa ga kowareru (mobile phone is broken), xxx 5 o kaikaeru (replace xxx5), cause}

Assuming that there are M types of relation labels, M types of labels are finally output.

When the above extraction method 2 is used, the relationship estimation device 100 uses a triple {phrase 1, phrase 2, relation label} as input.

(Extraction Method 3)

The triple {phrase 1, phrase 2, relation label} obtained by manually converting the connection expression to the relation label and the triple {phrase 1, phrase 2, relation label} obtained by the extraction method 2 are combined and output. M types of labels are finally output.

When the above extraction method 3 is used, the relationship estimation device 100 uses a triple {phrase 1, phrase 2, relation label} as input.

(Extraction Method 4)

The triple {phrase 1, phrase 2, relation label} obtained by manually converting the connection expression to the relation label and the triple {phrase 1, phrase 2, connection expression} obtained by the extraction method 1 are combined and output. N+M types of labels are finally output.

When the above extraction method 4 is used, the relationship estimation device 100 uses a triple {phrase 1, phrase 2, connection expression} or a triple {phrase 1, phrase 2, relation label} as input.

The learning unit 63 uses the triple {phrase 1, phrase 2, connection expression} extracted by the learning data generation unit 62 as correct learning data to learn the relationship estimation model.

As described above, the relationship estimation model uses a neural network (hereinafter referred to as NN) such as a multilayer perceptron to perform loss calculation by the following method to update NN parameters.

Note that the data used for learning is used by adding a negative example, and the data obtained by randomly replacing one element of the triple of the positive example is called the negative example.

(Loss Calculation Method 1)

In correspondence with the above described relation score calculation method 1, loss calculation is performed by the following expression.

Loss_triple(hinge)=Σmax(0,1+score(h,t,r)−score(h′,t′,r′)) [Formula 1]

Note that the score (h′,t′,r′) represents the score of the negative example. Examples of the loss calculation method may include hinge loss, sigmoid loss, and softmax loss.

(Loss Calculation Method 2)

In correspondence with the above described relation score calculation method 2, loss calculation is performed by the following expression.

Loss_triple(hinge)=Σmax(0,1−∥E_hr−E_t∥−∥E_hr′−E_t′∥) [Formula 2]

Note that E h′r′−E_t′ represents the score of the negative example. Examples of the loss calculation method may include hinge loss, sigmoid loss, and softmax loss.

<Operation of the Relationship Estimation Model Learning Device According to the Embodiment of the Present Invention>

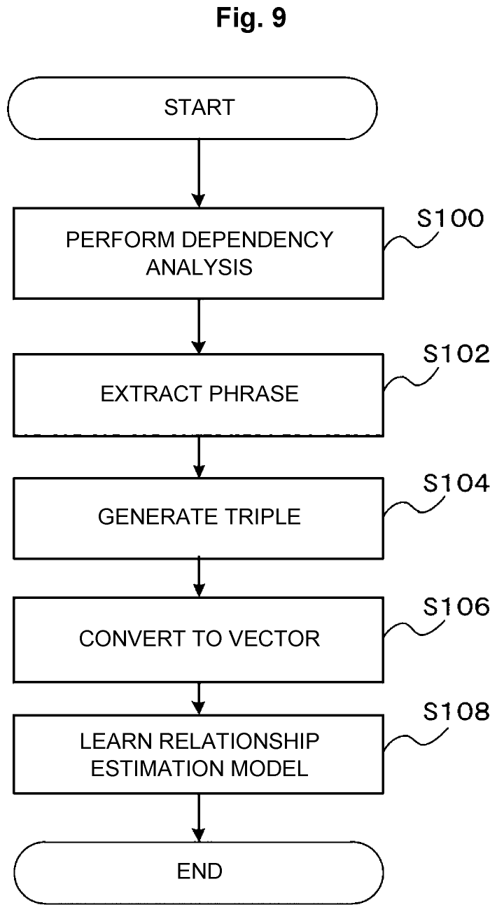

Then, the operation of the relationship estimation model learning device 150 according to the embodiment of the present invention will be described. When the input unit 50 receives an input text, the relationship estimation model learning device 150 performs the relationship estimation model learning processing routine as illustrated in FIG. 9.

First, in step S100, dependency analysis is performed on the input text.

Then, in step S102, a phrase is extracted based on the dependency analysis result of the input text.

In step S104, a phrase in a dependency relation with a segment containing the connection expression is extracted from a pair of phrases extracted in the step S102 thereby to generate a triple consisting of {phrase 1, phrase 2, connection expression}.

In step S106, the phrase 1, the phrase 2, and the label contained in the triple generated in step S104 are converted to the respective vectors.

Then, in step S108, the results obtained by converting the triple {phrase 1, phrase 2, connection expression} to the respective vectors are used as correct learning data to learn the relationship estimation model. Then, the relationship estimation model learning processing routine ends.

<Operation of the Relationship Estimation Device According to the Embodiment of the Present Invention>

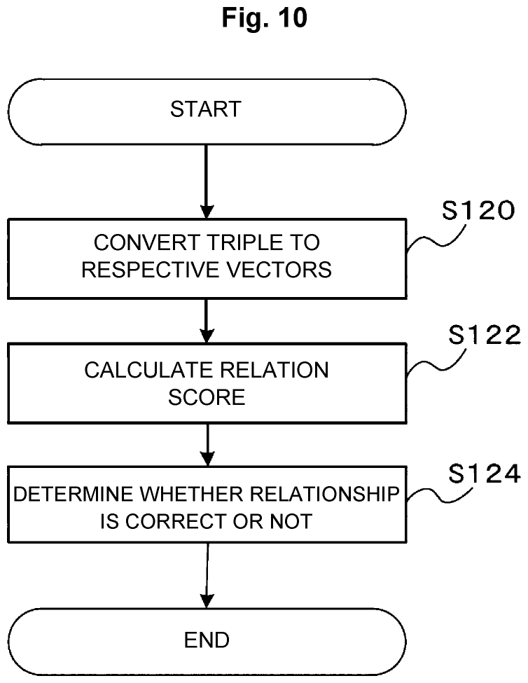

Then, the operation of the relationship estimation device 100 according to the embodiment of the present invention will be described. When the relationship estimation model that has been learned by the relationship estimation model learning device 150 is inputted to the relationship estimation device 100, the relationship estimation device 100 stores the relationship estimation model in the storage unit 22. Then, when the input unit 10 receives the triple {phrase 1, phrase 2, connection expression} to be estimated, the relationship estimation device 100 performs the relationship estimation processing routine illustrated in FIG. 10.

In step S120, the phrase 1, the phrase 2, and the label contained in the triple received by the input unit 10 are converted to the respective vectors.

In step S122, based on the results obtained by converting the triple {phrase 1, phrase 2, connection expression} to the respective vectors in step S120 and the relationship estimation model, the relation score is calculated.

In step S124, a determination is made whether or not the relation score calculated in step S122 is equal to or greater than a predetermined threshold, thereby to determine whether or not the phrase 1 and the phrase 2 has a relationship indicated by the label, and output the determination result from the output unit 40. Then, the relationship estimation processing routine ends.

As described above, based on the dependency analysis result of the input text, the relationship estimation model learning device according to the embodiment of the present invention extracts a pair of phrases having a dependency relationship with a segment containing a connection expression representing a relationship between phrases, and generates a triple consisting of the pair of phrases, and a connection expression or a relation label. By so doing, the relationship estimation model learning device according to the embodiment of the present invention can learn the relationship estimation model that can accurately estimate the relationship between phrases without incurring the cost of generating learning data.

Further, when the extraction method 1 or 2 is used, data of the triple extracted from the input text using the connection expression is used as learning data to build a neural relation knowledge estimation model of the phrase. By so doing, the neural relationship can be modeled based on the connection expression without manual data. Furthermore, a model can be built for calculating the relation score of a triple consisting of a predetermined relation label and any phrases without manual correct data.

The extraction method 2 can estimate an abstract relationship such as “cause” instead of the connection expression itself such as “node”.

Further, the extraction method 3 allows an error to be corrected for learning based on manually provided data even if the connection expression and the relation label do not correspond one-to-one (for example, the connection expression is “tame” and the relation label is “cause” and “purpose”).

Further, the extraction method 4 can estimate both the connection expression itself such as “node” and the abstract relationship such as “cause”. Furthermore, the extraction method 4 can obtain the effect of the extraction method 3. In a pattern that mixes the manually associated label and the connection expression, the extraction method 4 can build a model that can simultaneously consider a reliable label that can be manually converted and another label that cannot be manually converted.

Further, the relationship estimation device according to the embodiment of the present invention can accurately estimate the relationship between phrases.

Note that the present invention is not limited to the above described embodiments, and various modifications and applications can be made without departing from the spirit and scope of the present invention.

For example, the above described embodiments have described the case where the relationship estimation device 100 and the relationship estimation model learning device 150 are configured as separate devices, but the relationship estimation device 100 and the relationship estimation model learning device 150 may be configured as one device.

The above described relationship estimation model learning device and the relationship estimation device include a computer system therein. However, when the “computer system” uses a WWW system, a webpage providing environment (or display environment) is included.

### REFERENCE SIGNS LIST

10 input unit
20 calculation unit
21 estimation unit
22 storage unit
40 output unit
50 input unit
60 calculation unit
62 learning data generation unit
63 learning unit
71 basic analysis unit
72 phrase extraction unit
73 connection expression database
90 output unit
100 relationship estimation device
150 relationship estimation model learning device

1.-4. (canceled)

5. A computer-implemented method for estimating aspects of phrases, the method comprising:
receiving a text;
extracting, from the received text, a first predetermined connector expression and a first pair of phrases, the pair of phrases including a first phrase and a second phrase, the first predetermined connection expression indicating a relationship between the first phrase and the second phrase;
generating a set of data, the set of data comprising the extracted pair of phrases and information indicating the relationship between the first phrase and the second phrase; and
training, based on the generated set of data, a relationship estimation model for estimating the relationship based on a relationship score between a second pair of phrases, the first pair of phrases and the second pair of phrases being distinct.

6. The computer-implemented method of claim 5, wherein the information indicating the relationship between the first phrase and the second phrase includes the first predefined connection expression.

7. The computer-implemented method of claim 5, wherein the information indicating the relationship between the first phrase and the second phrase includes a relation label indicating a relationship represented by the first predefined connection expression.

8. The computer-implemented method of claim 5, wherein the relationship label indicating the relationship between the first phrase and the second phrase comprises at least one of: a result, a cause, and a purpose.

9. The computer-implemented method of claim 5, wherein the relationship estimation model is a neural network that takes as input the first phrase, the second phrase, and the information indicating the relationship between the first phrase and the second phrase for generating a relation score, and wherein the relations score indicates whether the first phrase and the second phrase indicating the relationship based on the first predefined connection expression.

10. The computer-implemented method of claim 5, wherein the relations score indicates a level of closeness of the relationship between the first phrase and the second phrase based on the first predetermined expression connector.

11. The computer-implemented method of claim 5, the method further comprising:
receiving a new text as input;
extracting, from the new text, the second pair of phrases and a second predetermined connector expression;
generating, using the trained relationship estimation model, a second relations score based on the second pair of phrases and a second predetermined connector expression; and
estimating, a relationship between phrases of the second pair of phrases based on the generated second relations score.

12. A system for estimating aspects of phrases, the system comprising:
a processor; and
a memory storing computer-executable instructions that when executed by the processor cause the system to:
receive a text;
extract, from the received text, a first predetermined connector expression and a first pair of phrases, the pair of phrases including a first phrase and a second phrase, the first predetermined connection expression indicating a relationship between the first phrase and the second phrase;
generate a set of data, the set of data comprising the extracted pair of phrases and information indicating the relationship between the first phrase and the second phrase; and
train, based on the generated set of data, a relationship estimation model for estimating the relationship based on a relationship score between a second pair of phrases, the first pair of phrases and the second pair of phrases being distinct.

13. The system of claim 12, wherein the information indicating the relationship between the first phrase and the second phrase includes the first predefined connection expression.

14. The system of claim 12, wherein the information indicating the relationship between the first phrase and the second phrase includes a relation label indicating a relationship represented by the first predefined connection expression.

15. The system of claim 12, wherein the relationship label indicating the relationship between the first phrase and the second phrase comprises at least one of: a result, a cause, and a purpose.

16. The system of claim 12, wherein the relationship estimation model is a neural network that takes as input the first phrase, the second phrase, and the information indicating the relationship between the first phrase and the second phrase for generating a relation score, and wherein the relations score indicates whether the first phrase and the second phrase indicating the relationship based on the first predefined connection expression.

17. The system of claim 12, wherein the relations score indicates a level of closeness of the relationship between the first phrase and the second phrase based on the first predetermined expression connector.

18. The system of claim 12, the computer-executable instructions when executed further cause the system to:
receive a new text as input;
extract, from the new text, the second pair of phrases and a second predetermined connector expression;
generate, using the trained relationship estimation model, a second relations score based on the second pair of phrases and a second predetermined connector expression; and
estimate, a relationship between phrases of the second pair of phrases based on the generated second relations score.

19. A computer-readable non-transitory recording medium storing computer-executable instructions that when executed by a processor cause a computer system to:
receive a text;
extract, from the received text, a first predetermined connector expression and a first pair of phrases, the pair of phrases including a first phrase and a second phrase, the first predetermined connection expression indicating a relationship between the first phrase and the second phrase;
generate a set of data, the set of data comprising the extracted pair of phrases and information indicating the relationship between the first phrase and the second phrase; and
train, based on the generated set of data, a relationship estimation model for estimating the relationship based on a relationship score between a second pair of phrases, the first pair of phrases and the second pair of phrases being distinct.

20. The computer-readable non-transitory recording medium of claim 19, wherein the information indicating the relationship between the first phrase and the second phrase includes the first predefined connection expression.

21. The computer-readable non-transitory recording medium of claim 19, wherein the information indicating the relationship between the first phrase and the second phrase includes a relation label indicating a relationship represented by the first predefined connection expression.

22. The computer-readable non-transitory recording medium of claim 19, wherein the relationship label indicating the relationship between the first phrase and the second phrase comprises at least one of: a result, a cause, and a purpose.

23. The computer-readable non-transitory recording medium of claim 19, wherein the relationship estimation model is a neural network that takes as input the first phrase, the second phrase, and the information indicating the relationship between the first phrase and the second phrase for generating a relation score, and wherein the relations score indicates whether the first phrase and the second phrase indicating the relationship based on the first predefined connection expression.

24. The computer-readable non-transitory recording medium of claim 19, wherein the relations score indicates a level of closeness of the relationship between the first phrase and the second phrase based on the first predetermined expression connector.
